(19) United States
(12) Patent Application Publication
(10) Pub. No.: US 2006/0049318 A1
(43) Pub. Date: Mar. 9, 2006

(54) Fiber optic coupler mounting bracket

(76) Inventors: Todd A. Newhouse, Rohnert Park, CA (US); Christopher M. Hankins, Santa Rosa, CA (US)

Correspondence Address: PILLSBURY WINTHROP SHAW PITTMAN LLP, P.O. BOX 10500, MCLEAN, VA, 22102, US

(21) Appl. No.: 10/936,982

(22) Filed: Sep. 8, 2004

(51) Int. Cl. F16B 15/00; A47F 5/00

(52) U.S. Cl. 248/71; 248/205.1

(57) ABSTRACT

In one embodiment, a bracket for attaching a Fiber Optic Coupler to a surface such as a printed circuit board. The bracket attaches to the surface using integrated latching fasteners and receives a coupler such as an SC-type coupler. Such a bracket may operate using no additional hardware, and may be constructed as a molding or may utilize subcomponents according to desired operating characteristics including flexibility, elasticity and friction.

### BACKGROUND

1. Field of the Invention

Generally, the present invention relates to cable management. Specifically, this invention relates to fiber optic cable management.

2. Description of Related Art

Most telecommunications networks of today are based on active components at the serving office exchange and termination points at the customer premises as well as in the repeaters, relays and other devices in the transmission path between the exchange and the customer. In this context, active components are devices that require power of some sort, and generally comprise processors, memory chips and other devices that are active and processing information within and along the transmission path.

In contrast, within a typical passive optical network (PON), passive optical components are used to guide traffic between the central office exchange and the customers' premises based on splitting the power of optical wavelengths to endpoints along the way. This replacement of active components with passive components provides a cost-savings to service providers by eliminating the need to power and service active components in the transmission loop. The passive splitters or couplers merely pass or restrict light, and as such, have no power or processing requirements. For example, two subscription channel (“SC”) connectors may be coupled using an SC-type coupler, where an SC connector is a push-pull type of optical connector that features high packing density, low loss, low back-reflection, and low cost.

In general, a typical PON consists of an optical line terminator (OLT), which is located at a central office (CO), and a set of associated optical network terminals (ONTs), which are located at customers' premises. Between the OLT and the ONTs lies one or more optical distribution networks (ODNs), each ODN including fibers and one or more of passive splitters and passive couplers.

Typically a multitude of parts (such as a sheet metal bracket, rivets, screws and lock washers) is used to fasten a fiber optic coupler to a printed circuit board (“PCB”) assembly. The multitude of parts in the assembly increases the time, expense and cost of labor required to install, remove or adjust the coupler. Additionally, the use of the rivets, screws and lock washers to secure the sheet metal bracket to the PCB assembly may crush the PCB locally and create short circuits within the buried traces of the PCB. Further, rework of a PCB with a coupler attached by rivets entails drilling out the rivets thereby creating a risk of further damage to the PCB, additional expense, and additional labor costs.

What is needed is a fiber optic coupler that can be quickly and reliably installed on a PCB assembly with minimal mechanical force and few additional components.

### SUMMARY

In one embodiment, a bracket configured to secure a fiber optic coupler to a surface includes a base having a first side and a second side opposite to the first side. The bracket includes first and second side portions, said first and second side portions being provided on the first side of the base and being arranged to receive the coupler between them. The bracket includes first and second legs provided on the second side of the base and being configured to secure the bracket to the surface. In response to application of a lateral force to at least one of the first and second side portions, the bracket is deformable from a first configuration to a second configuration. In the first configuration, the first and second legs are positioned relative to one another to prevent removal of the bracket from the surface without damage to the bracket. In the second configuration, the first and second legs are positioned relative to one another to permit removal of the bracket from the surface without damage to the bracket. Presence of the coupler between the first and second side portions prevents deformation of the bracket from the first configuration to the second configuration in response to said application of lateral force.

In another embodiment, a method for securing a fiber optic coupler to a surface using a bracket includes deforming the bracket from a first configuration to a second configuration and, while the bracket is in the second configuration, inserting at least one portion of the bracket into at least one corresponding hole in the surface. The method includes, subsequent to said inserting, allowing the bracket to return at least substantially to the first configuration such that said at least one portion is arranged to secure the bracket to the surface.

In another embodiment, a bracket for securing a fiber optic coupler to a surface includes means for supporting the bracket, the means being deformable from a first configuration to a second configuration, and means for securing the bracket to the surface when the means for supporting is in the first configuration. The bracket includes means for inhibiting movement of the fiber optic coupler relative to the bracket when the means for supporting is in the first configuration.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a mechanical drawing showing an exemplary embodiment of the invention;

FIG. 2 is an assembly drawing illustrating the coupling of an exemplary bracket with an SC-type coupler.

FIG. 3 shows a solder-side view of the legs of the exemplary bracket after attachment to a PCB.

FIG. 4 shows a method of attaching the exemplary bracket to a PCB.

FIG. 5 is an assembly drawing showing an embodiment of the invention as installed on an exemplary printed circuit board assembly.

### DETAILED DESCRIPTION

Embodiments of the present invention will now be described in detail with reference to the drawings, which are provided as illustrative examples so as to enable those skilled in the art to practice the invention. Notably, the figures and examples below are not meant to limit the scope of the present invention. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

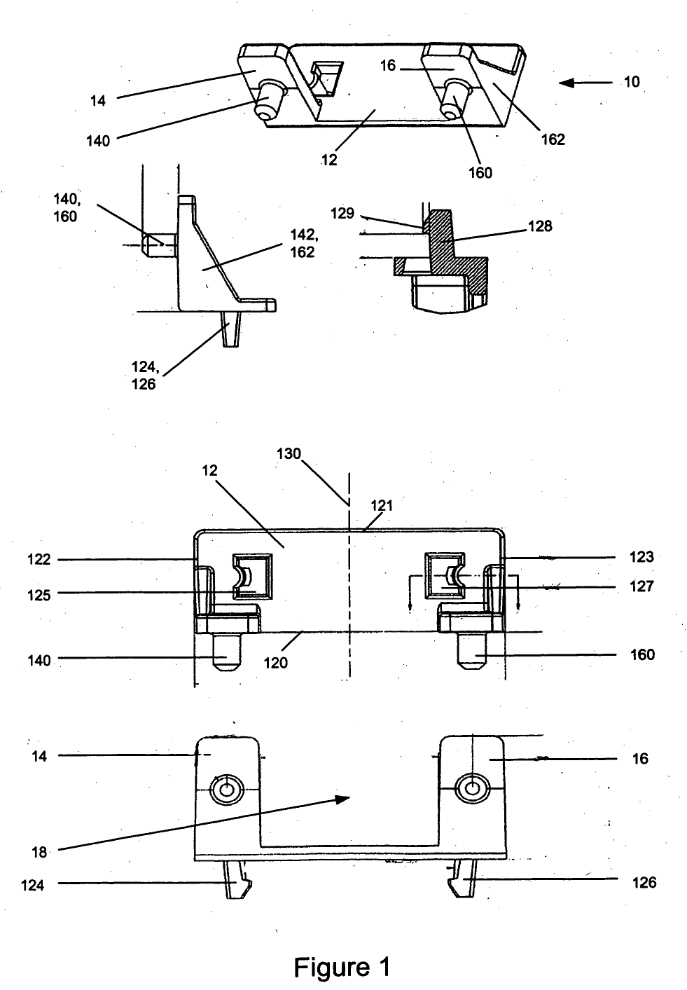

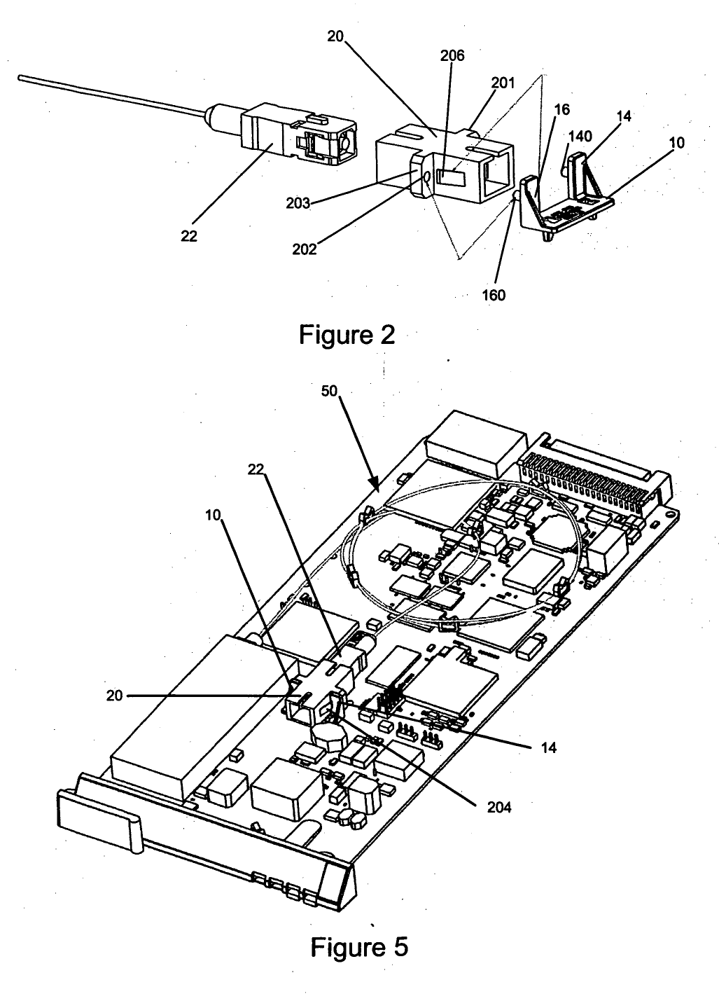

Referring to FIGS. 1 and 2, an exemplary embodiment of a fiber optic coupler mounting bracket 10 is shown. For the sake of clarity and for better illustration, an embodiment of the invention adapted to receive an SC-type coupler will be described. It will be appreciated, however, that various embodiments of the invention may receive coupler types including: SC-type for subscription channel connectors; LC-type, for precision physical contact, push-pull connectors; MU-type, for compact multiple optical connectors and couplers or adapters for connecting two or more dissimilar types of connectors; and/or other connector and/or coupler types in current or future use. It will be further appreciated, by one skilled in the art, that the geometry and dimensions of the bracket may be modified and customized according to the configuration of any selected coupler. For example, curved lines may be substituted for straight lines, inclined members may replace vertical members, and so on. Embodiments of the invention may also be adapted to attach connectors and connector assemblies to a surface.

While the bracket 10 may be constructed as an assembly of a plurality of subcomponents, in at least some embodiments the bracket 10 is a single molded component. In other embodiments, the bracket or elements thereof may be stamped or cut from, e.g. a sheet of material. The bracket 10 may be fabricated from any one or more suitable materials including, for example, polycarbonate resin such as GE Lexan 923A, thermoplastic, thermoset resin, sheet metal, composite and molded rubber.

In this exemplary embodiment, the bracket comprises a base 12, a left side portion 14 and a right side portion 16. The base 12 may be flat and generally rectangular with a front edge 120, a back edge 121, a left edge 122 and a right edge 123. The base 12 may have a thickness selected according to the properties of the fabrication material to provide a desired flexibility and a desired elasticity such that the bracket 10 may be bendable to facilitate insertion on a PCB (or other surface or sheet-like material), as discussed below and shown in FIG. 4. In some embodiments, the base 12 may have a varying thickness e.g. so as to promote bending at a particular location and/or provide additional support or rigidity at another location.

In this embodiment, the left side portion 14 rises vertically from the base 12 and is located on and along the front edge 120 of the base 12, such that the left side portion 14 shares a corner with the front edge 120 and the left edge 122 of the base 12. Similarly, the right side portion 16 rises vertically from the base 12 and is located on and along the front edge 120 of the base 12, such that the right side portion 16 shares a corner with the front edge 120 and right edge 123 of the base 12. In other embodiments, the base 12 may extend beyond the side portions 14, 16 in one or both directions. In further embodiments, the side portions 14, 16 may be oriented along the respective left and right edges 122, 123.

In this embodiment, a left supporting member 142 (not visible) connects a vertical edge of the left side portion 14 to the left side 122 of the base 12, and a right supporting member 162 connects a vertical edge of the right side portion 16 to the right side 123 of the base 12. The left supporting member 142 and the right supporting member 162 may be discrete linear or curved members or may be angular solid walls. In other embodiments, the left and right supporting members may extend from the surface of base 12 and/or the adjacent surface of the corresponding side portion 14, 16, rather than connecting to an edge of the base and/or side portion. In further embodiments, the supporting members may be spaced to enclose a coupler intended to be seated therebetween.

In this embodiment, the left side portion 14 and the right side portion 16 form two sides of a slot 18 in the front vertical plane of the bracket 10, and the front edge 120 of the base 12 forms the third side of the slot 18. In the exemplary embodiment, the slot 18 is configured to receive a coupler 20. In some embodiments of the invention, an insert, washer or other intermediary may be used to seat the coupler 20. Depending e.g. on the particular configuration of the coupler intended to be seated therein, other embodiments may include a front portion extending vertically from base 12 between the side portions 14, 16.

The dimensions of the slot 18 may be selected according to the dimensions of the coupler 20 (see FIG. 2). In one exemplary embodiment where the bracket 10 attaches an SC-type coupler 20, the slot has a nominal horizontal dimension (i.e. parallel to the front side 120) of 13.01 mm (0.512″) and a nominal vertical height of 10.41 mm (0.410″). It will be appreciated that the dimensions may be altered to permit the bracket 10 to receive other couplers, adapters and connectors of different sizes. It will be further appreciated that the dimensions of the slot 18 may be adjusted e.g. according to manufacturing and operational tolerances of the material(s) used to fabricate the bracket 10.

The base and/or one or both side portions 14, 16 may also include one or more indentations (e.g. holes) or protrusions configured to mate with corresponding features of the coupler. In the embodiment illustrated in FIG. 1, for example, a left locating pin 140 extends forward from the front of the left side portion 14, and a right locating pin 160 extends forward from the front of the right side portion 16, these pins being located to mate with corresponding holes in an SC-type coupler. In some embodiments, protrusions such as the right pin 160 and the left pin 140 may be constructed from or have a surface comprising a low friction material such as steel, aluminum, certain plastics, Teflon, composites, or rubber.

A left leg 124 may be attached to the bottom of the base 12, to the left of a center line 130 drawn from the front side 120 of the base to the back side of the base 12, equidistant from the left side 122 and right side 123. A right leg 126 may be attached to the bottom of the base 12, to the right of the center line 130. Both the left leg 124 and right leg 126 may have a post-like form 128 with a lip 129, wherein the lip 129 is separated from the bottom surface of base 12 (e.g. by a thickness of a surface to which the bracket is intended to be attached).

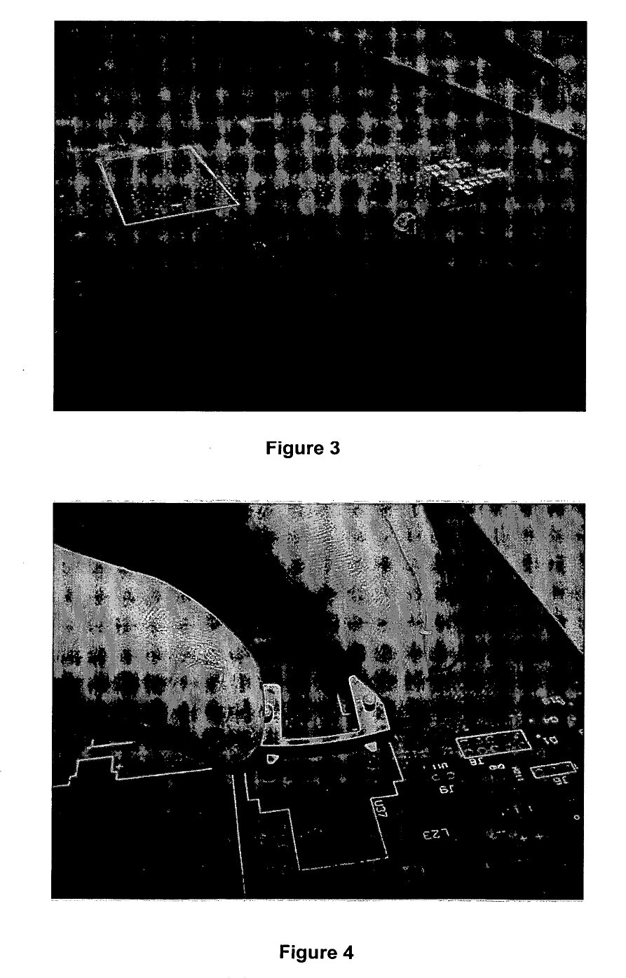

Referring now also to FIGS. 3 and 4, the dimensions of the lip 129 and the distance of the lip 129 from the base 12 are selected to allow the left leg 124 and right leg 126 to fasten the bracket 10 to a sheet-like material such as a PCB 30. The bracket 10 may be attached to the PCB 30 by inserting the left leg 124 and right leg 126 into a left hole 32 and a right hole 34 of the PCB, respectively. The left hole 32 and the right hole 34 may have a diameter sufficient to allow a vertically oriented leg 124 and 126 to pass through the board without obstructing the lip 129.

The left leg 124 and the right leg 126 may be aligned such that the respective lips 129 are oriented toward the center line 130 thereby minimizing the distance between the lips 129. Further, the posts 128 of the legs 123 and 124 may be inclined relative to the base 12 such that, when inserted into the holes 34 and 35, the lips 129 extend beyond the perimeter of the holes 34 and 35 and overhang the PCB 30. Thus, once attached, the bracket 10 may resist detachment due to force applied either incidentally or deliberately by, for example, pulling on a fiber cable 22 connected to a coupler 20 held by the bracket 10.

In some embodiments, the bracket 10 is attached and detached from the surface by bending the bracket 10 generally about the center line 130. Such bending may increase the distance between the lips 129 of the legs and thus eliminate the overhang of the lip 129 with respect to the corresponding hole (see FIG. 4). In the exemplary embodiment, bending the bracket 10 brings the left and right legs 123 and 124 into a parallel alignment, allowing the legs 123 and 124 to negotiate the holes 34 and 35 without obstruction.

In some embodiments, a left opening 125 and a right opening 127 may be created on the base 12 adjacent to the left leg 124 and the right leg 126, respectively, each opening extending in the direction of the center line 130. The openings 125 and 127 may provide additional flexibility, allowing the legs 124 and 126 to be bent away from center line 130 for easy attachment and detachment of the bracket 10 with respect to the PCB 30. The openings 125 and 127 may also facilitate using a tool (such as a screwdriver) to bend the legs 124 and 126, thereby facilitating attachment or detachment of the bracket.

Referring now to FIGS. 1 and 2, an application of the exemplary embodiment is illustrated. The bracket 10 receives the SC-type coupler 20, wherein the type, form, dimensions and composition of the SC-type coupler 20 are known to one skilled in the art. In turn, the SC-type coupler 20 may receive a first fiber cable 22, and a second fiber cable 24 (not shown), thereby connecting the first cable 22 to the second cable 24. The left locating pin 140 and the right locating pin 160 matingly couple to a left hole 200 (not shown) and a right hole 202, respectively. The left hole 200 and the right hole 202 are located on a left flange 201 and a right flange 203 of the coupler, respectively. The dimensions of the pins 140 and 160 are selected such that, when coupled with the holes 200 and 202, rotation, shear and skew of the SC coupler 20 relative to the bracket 10 may be resisted.

A left retaining clip 204 (not shown) located on a left side of the SC connector 20 engages with the left side portion 14, and a right retaining clip 206 located on a right side of the SC connector 20 engages with the right side portion 16. When engaged, the retaining clips prevent retraction of the SC-type coupler 20 from the bracket 10. In other embodiments, one or both of the side portions 14, 16 may include a protrusion that retains the coupler to the bracket by engaging the top surface of the coupler.

A potential advantage of at least some embodiments of the invention is a self-locking nature of the bracket 10. In the exemplary embodiment, for example, once the SC-type coupler 20 is coupled to the bracket 10, it may no longer be possible to bend the base 12 about the center line 130. As a result, the bracket 10 may not be easily removed unless the SC-type coupler 20 is first retracted from the bracket 10.

Referring now to FIG. 5 and for the purpose of illustration, a drawing of an exemplary bracket 10 is shown installed on a populated PCB 50. An SC coupler 20 is shown attached to the bracket 10. The left retaining clip 204 is shown engaged with the left side wall 14. Further the first cable 22 is shown attached to the SC coupler 20.

At least some embodiments as described herein provide cost effective means to mount a Fiber Optic Coupler on a PCB. Embodiments of the present invention include a bracket that permits the attachment of a SC-type (“Subscription Channel”) coupler to a surface such as a PCB assembly without additional hardware components to secure the bracket. Embodiments of the invention also include a bracket that may be formed as a single molded piece. In some embodiments, the bracket may be constructed by combining components manufactured from various materials including sheet metal, composites, molded rubber, polycarbonate resin, thermoplastic, thermoset resin, steel, aluminum and Teflon. A bracket according to at least some embodiments may be easily installed to a PCB (for example), yet remain firmly attached while in use. A bracket according to at least some embodiments may be easily dismounted for maintenance, inspection and repair.

It is apparent that the above embodiments may be altered in many ways without departing from the scope of the invention. For example and with reference to FIGS. 1 and 3, in some embodiments, the left leg 124 and the right leg 126 may be flexible and the base 12 may be rigid, such that attachment of the bracket 10 to the PCB 30 entails bending the legs 124 and 126 to pass the legs 124 and 126 through holes 32 and 34 in the PCB 30. In another exemplary embodiment, the left leg 124, the right leg 126 and the base 12 may be rigid, the legs 124 and 126 being connected to the base 12 in a hinged manner such that attachment to the PCB 30 entails bending the legs 124 and 126 to pass the legs 124 and 126 through holes 32 and 34 in the PCB 30. Also, a variety of couplers may be secured using embodiments of the invention, including couplers that couple non-homogenous connectors including, for example, LC/SC couplers. Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents.

What is claimed is:

1. A bracket configured to secure a fiber optic coupler to a surface, and also configured to permit elastic deformation of the bracket upon application of a lateral force, the bracket comprising:
a base having a first side and a second side opposite to the first side;
first and second side portions, each portion extending from the first side of the base and being arranged apart from each other, thereby being adapted to receive the coupler between them; and
first and second legs provided on the second side of the base and being configured to secure the bracket to the surface,
wherein, in response to application of the lateral force to at least one of the first and second side portions, the alignment of the legs with respect to one another is changed from a first configuration to a second configuration that is different from the first configuration and, upon removal of the lateral force, the alignment of the legs with respect to one another reverts to the first configuration, and
wherein in the first configuration, the first and second legs are positioned relative to one another to resist removal of the bracket from the surface, and
wherein in the second configuration, the first and second legs are positioned relative to one another to permit removal of the bracket from the surface, and
wherein presence of the coupler between the first and second side portions prevents deformation of the bracket and prevents realigning of the first and second legs from the first configuration to the second configuration in response to the application of the lateral force.

2. The bracket according to claim 1, wherein the first side portion is adapted to engage with a first clip of an SC-type coupler and the second side portion is adapted to engage with a second clip of the SC-type coupler.

3. The bracket according to claim 1, wherein a first protrusion extends from the first side portion and a second protrusion extends from the second side portion, the first and second protrusions being adapted to mate with corresponding indentations of the coupler.

4. The bracket according to claim 1, wherein the first side portion includes a first indentation and the second side portion includes a second indentation, the first and second indentations being configured to mate with corresponding protrusions of the coupler.

5. A method for securing a fiber optic coupler to a surface using a bracket, the method comprising:
deforming the bracket from a first configuration to a second configuration;
while the bracket is in the second configuration, inserting at least one portion of the bracket into at least one corresponding hole in the surface;
subsequent to the inserting, allowing the bracket to return at least substantially to the first configuration such that the at least one portion is arranged to secure the bracket to the surface; and
attaching the fiber optic coupler to the bracket.

6. The method for securing a fiber optic coupler according to claim 5, wherein the attaching the fiber optic coupler to the bracket includes attaching an SC-type coupler to the bracket.

7. The method for securing a fiber optic coupler according to claim 5, wherein the deforming the bracket includes changing a dimension of an opening of the bracket,
wherein in the first configuration, the opening is dimensioned to receive a corresponding portion of the coupler, and
wherein in the second configuration, the opening is smaller than the corresponding portion of the coupler.

8. The method for securing a fiber optic coupler according to claim 5, wherein the surface is a two-sided sheet material, and
wherein the inserting at least one portion into at least one corresponding hole includes inserting each of two legs of the bracket into a corresponding hole of the surface, each of the two legs including a protrusion adapted to secure the bracket to the sheet material.

9. The method for securing a fiber optic coupler according to claim 5, wherein the inserting at least one portion includes inserting at least one leg, and
wherein the at least one leg is configured to grasp a side of a sheet material opposite to a side of the sheet material from which the inserting is initiated.

10. The method for securing a fiber optic coupler according to claim 5, wherein the at least one portion includes two flexible legs, and
wherein the deforming comprises bending the flexible legs away from each other.

11. The method for securing a fiber optic coupler according to claim 5, wherein the at least one portion includes two flexible legs, and
wherein the deforming comprises bending the flexible legs toward each other.

12. The method for securing a fiber optic coupler according to claim 5, wherein the attaching the coupler to the bracket prevents deformation of the bracket from the first configuration to the second configuration.

13. The method for securing a fiber optic coupler according to claim 5, wherein the coupler includes a retainer, and
wherein the attaching includes engaging the retainer with a portion of the bracket to inhibit removal of the coupler from the bracket.

14. The method for securing a fiber optic coupler according to claim 5, wherein the coupler includes a retainer, and
wherein the attaching includes moving the coupler in a first direction relative to the bracket to engage the retainer with a portion of the bracket, and
wherein the engaging inhibits moving the coupler relative to the bracket in a direction opposite to the first direction.

15. The method for securing a fiber optic coupler according to claim 5, wherein the attaching includes engaging a protrusion of one among the coupler and the bracket with a corresponding indentation of the other among the coupler and the bracket.

16. A bracket for securing a fiber optic coupler to a surface, the bracket comprising:
means for supporting the bracket, the means being deformable from a first configuration to a second configuration;
means for securing the bracket to the surface when the means for supporting is in the first configuration; and
means for inhibiting movement of the fiber optic coupler relative to the bracket when the means for supporting is in the first configuration.

17. The bracket of claim 16, wherein deformation of the means for supporting from the first configuration to the second configuration is inhibited when the means for inhibiting movement of the fiber optic coupler is operative.

18. A method for securing a fiber optic coupler to a surface using a flexible bracket, wherein the flexible bracket has legs that are not parallel to each other while in a resting position and wherein the flexible bracket has an opening, the method comprising the steps of:
bending the flexible bracket such that the shape of the opening is deformed and the legs are aligned parallel to one to another;
inserting the legs into corresponding holes formed in the surface;
releasing the flexible bracket to restore the shape of the opening and to cause the legs to return to the resting position and thereby secure the flexible bracket to the surface; and
attaching the fiber optic coupler to the flexible bracket by inserting the fiber optic coupler into the opening.

19. The method for securing a fiber optic coupler according to claim 18, wherein the attaching the fiber optic coupler to the flexible bracket includes attaching an SC-type coupler to the flexible bracket.

20. The method for securing a fiber optic coupler according to claim 18, wherein the surface is a two-sided sheet material, and
wherein the inserting the legs into the corresponding holes includes inserting each of the legs of the flexible bracket into a corresponding hole of the surface, each of the legs including a protrusion adapted to secure the flexible bracket to the sheet material.

21. The method for securing a fiber optic coupler according to claim 18, wherein the legs are configured to grasp a side of a sheet material opposite to a side of the sheet material from which the inserting is initiated.

22. The method for securing a fiber optic coupler according to claim 18, wherein the coupler includes a retainer, and
wherein the attaching includes engaging the retainer with a portion of the flexible bracket to inhibit removal of the coupler from the flexible bracket.

23. The method for securing a fiber optic coupler according to claim 18, wherein the coupler includes a retainer, and
wherein the attaching includes moving the coupler in a first direction relative to the flexible bracket to engage the retainer with a portion of the flexible bracket, and
wherein the engaging inhibits moving the coupler relative to the flexible bracket in a direction opposite to the first direction.

24. The method for securing a fiber optic coupler according to claim 18, wherein the attaching includes engaging a protrusion of one among the coupler and the flexible bracket with a corresponding indentation of the other among the coupler and the flexible bracket.
